(19) United States
(12) Patent Application Publication
(10) Pub. No.: US 2017/0174573 A1
(43) Pub. Date: Jun. 22, 2017

(54) SYNTHETIC GASKET MATERIALS FOR USE IN HIGH PRESSURE HIGH TEMPERATURE PRESSES

(71) Applicant: MORGAN ADVANCED CERAMICS, INC., Hayward, CA (US)

(72) Inventors: Richard CLARK, Charlotte, NC (US); Gary HARLAND, Camas, WA (US); Mirco PAVONI, Eschwege (DE)

(21) Appl. No.: 15/129,544

(22) PCT Filed: Apr. 1, 2015
(86) PCT No.: PCT/EP2015/057275

§ 371 Date: Sep. 27, 2016

Related U.S. Application Data
(60) Provisional application No. 61/974,132, filed on Apr. 2, 2014.

(51) Int. Cl. C04B 33/13; F16J 15/10; C04B 33/30; C04B 35/626; C04B 33/04; C04B 33/20

(52) U.S. Cl. CPC C04B 33/1315; C04B 33/04; C04B 33/131; C04B 33/20; C04B 33/30; C04B 35/62695; F16J 15/102; C04B 2235/349; C04B 2235/3826; C04B 2235/3409; B30B 11/004

(57) ABSTRACT

A gasket material for high pressure high temperature presses, comprising: a proportion of a clay mineral a proportion of a hard material for increasing the viscosity of the clay mineral a proportion of a binder selected from the group of borate binders, phosphate binders, and mixtures thereof.

This invention relates to synthetic gasket materials for high pressure high temperature (HPHT) presses and encompasses gaskets made from such materials.

HPHT presses are used in a number of applications but the principal one of note is for the manufacture or growth of synthetic diamond. In such applications gasket materials are required that can withstand the high pressures and temperatures involved. [For example of the order of 1500° C. and pressures of 6 GPa or more].

Typically such gaskets may be of varying form [for example, without limitation, being cubic, cylindrical or of more complex form to suit press geometry].

Such gasketing materials and methods of making same are disclosed in U.S. Pat. No. 5,858,525 and U.S. Pat. No. 6,338,754 the contents of which are hereby incorporated by way of reference.

U.S. Pat. No. 5,858,525 discloses the use binders in gasket composition, the binders comprising “the group of materials including sodium silicate, acrylic copolymers, arabic gum, portland cement and the like”. U.S. Pat. No. 6,338,754 used sodium silicate binders. The applicants propose improved binder systems.

The present invention comprises a gasket material comprising:
a proportion of a clay mineral
a proportion of a hard material for increasing the viscosity of the clay mineral
a proportion of a binder selected from the group of borate binders, phosphate binders, and mixtures thereof.

By clay mineral is meant a silicate material of fine particle size. A non-exhaustive list of clay minerals is provided in U.S. Pat. No. 5,858,525, which list is incorporated by reference.

The proportions of clay mineral to hard material may (but does not have to) lie in the respective ratios 1-10:10-1.

The proportion of binder to the combined amount of clay mineral and hard material may (but does not have to) lie in the respective ratios 1:1-100.

The total amount of clay mineral, hard material, and binder may lie in the range 70-100 wt % of the gasket material.

The clay mineral may be (but does not have to be) clays selected from the group consisting of akermanite, bertandite, kaolinite, pyrophyllite, prehnite, pyrope, scolecite, serpentine, talc, zoisite, and mixtures thereof.

The hard material material may be (but does not have to be) selected from the group consisting of silica, zircon, garnet, silicon carbide, boron carbide, alumina, zirconia, kyanite, mullite, and mixtures thereof.

A borate binder system may be (but does not have to be) a solution of boric acid and water comprising both liquid and solid form. The solution formed from such mixture may be super-saturated in form, heated above room temperature, and combined with other ingredients at elevated temperature.

A phosphate binder may be (but does not have to be) formed by reaction of an acid phosphate with a sparsely soluble oxide or an oxide mineral. Phosphate binders may comprise both solid and liquid components but conveniently binders comprising only solid components may be used. Typical phosphate binders include magnesium phosphate and aluminium phosphate but other phosphate binders may be used.

An advantage of borate and phosphate binders, versus sodium silicate is equipment cleanability—once sodium silicate sets, it needs to be chipped out. With borate binders such as boric acid, or phosphate binders, hot water will clean the equipment of unset material.

Manufacture of the gasket material may include the steps of dispersing the solid constituents, blending them, and pressing.

The solid constituents may be dispersed in a solution (e.g. a water solution of Boric Acid/Borax) and spray dried to provide a dispersed and intimately mixed material that will flow under pressing. Once the binder sets, such easy flow will be prevented.

The solid constituents may be granulated to ensure uniformity of distribution and improved pressing properties.

Pressing may include uniaxial pressing or isostatic pressing, or any form of pressing that provides the required density in the pressed product.

A typical composition might be:

| | |
|---|---|
| Clay mineral | 60-90 wt % |
| Hard material | 5-35 wt % |
| Binder | 5-25 wt % |

and for example may comprise:

| | |
|---|---|
| Clay mineral | 65 ± 4 wt % |
| Hard material | 15 ± 5 wt % |
| Binder | 5-25 wt %. |

Typical combinations of clay mineral and hard material include but are not limited to:
Talc and garnet
Pyrophyllite and garnet
Talc and zircon
Pyrophyllite and zircon

However, generally the combination of:
each and every clay mineral or combination thereof; with
each and every hard material and combinations thereof; with
each and every borate or phosphate binder and combinations thereof; should be considered as falling within the scope of the invention.

The clay and hard material may have a fine particle size, for example being −200 mesh or −230 mesh or −270 mesh or −325 mesh or even finer. However coarser particle sizes are not excluded.

### EXAMPLES

In the following examples:
talc was used as the clay mineral [the commercial grade “Micron 554” from Emerys. It is a −325 mesh material with a mean particle size of 3 microns];
−220 mesh silicon carbide was used, although finer material is preferred;
examples #1 and #3 are prophetic examples.

Powders of examples #2, #4, and #5 indicated below were manufactured by using hot water to dissolve the boric acid, then adding the other ingredients, then drying to form a powder.

This powder was subsequently pressed in a laboratory uni-axial Carver press to a pressure of about 103 MPa (15,000 psi) to form sample discs for evaluation.

The discs prepared were found to be consolidated.

Assessment of the brittleness of the discs by crushing in a mortar and pestle back to a pressable powder showed that higher clay content (in the case of these examples, talc) improved the materials, in that Examples #4, and #5 appeared more brittle than Example #2.

| | #1 | #2 | #3 | #4 | #5 |
|---|---|---|---|---|---|
| Talc | 65% | 65% | 45% | 45% | 60% |
| B₄C | 15% | 0% | 25% | 0% | 0% |
| SiC | 0% | 15% | 0% | 25% | 20% |
| Boric acid | 20% | 20% | 30% | 30% | 20% |
| Total: | 100% | 100% | 100% | 100% | 100% |

For phosphate binders prospective embodiments include:

| Dry mix | | | | |
|---|---|---|---|---|
| Talc | 70% | 70% | 70% | 70% |
| B₄C | 20% | 20% | 0% | 30% |
| SiC | 10% | 10% | 30% | 0% |
| Total dry mix | 100% | 100% | 100% | 100% |
| Phosphate binder (as % of dry mix) | 10% | 15% | 15% | 15% |

These examples and prospective embodiments are indicative of materials that may be made in accordance with the invention and the invention is not restricted thereto.

1. A gasket material for high pressure high temperature presses, comprising:
i. a proportion of a clay mineral
ii. a proportion of a hard material for increasing the viscosity of the clay mineral
iii. a proportion of a binder selected from the group of borate binders, and mixtures of borate binders and phosphate binders.

2. The gasket material as claimed in claim 1, in which the proportions of clay mineral to hard material lie in the respective ratios 1-10:10-1.

3. The gasket material as claimed in claim 1, in which the proportion of binder to the combined amount of clay mineral and hard material lies in the respective ratios 1:1-100.

4. The gasket material as claimed in claim 1, in which the total amount of clay mineral, hard material, and binder lies in the range 70-100 wt % of the gasket material.

5. The gasket material as claimed in claim 1, comprising:

| | |
|---|---|
| Clay mineral | 60-90 wt % |
| Hard material | 5-35 wt % |
| Binder | 5-25 wt % |

6. The gasket material as claimed in claim 5, comprising 61 wt % or more clay mineral.

7. The gasket material as claimed in claim 6, comprising:

| | |
|---|---|
| Clay mineral | 65 ± 4 wt % |
| Hard material | 15 ± 5 wt % |
| Binder | 5-25 wt % |

8. The gasket material as claimed in claim 1, in which the clay mineral is selected from the group consisting of akermanite, bertandite, kaolinite, pyrophyllite, prehnite, pyrope, scolecite, serpentine, talc, zoisite, and mixtures thereof.

9. The gasket material as claimed in claim 1, in which the hard material is selected from the group consisting of silica, zircon, garnet, silicon carbide, boron carbide, alumina, zirconia, kyanite, mullite, and mixtures thereof.

10. A method of making a gasket material as claimed in claim 1, comprising the steps of dispersing the solid constituents, blending them, and pressing.

11. The method as claimed in claim 10, in which dispersing and blending the solid constituents comprises dispersal of the solid constituents in a solution to form a suspension, and spray drying the suspension.

12. The method as claimed in claim 10, in which the solid constituents are granulated.

13. A gasket formed from the gasket material of claim 1.
